(19) United States
(12) Patent Application Publication
(10) Pub. No.: US 2014/0326703 A1
(43) Pub. Date: Nov. 6, 2014

(54) EXTENDED CASCADE PLASMA GUN

(71) Applicants: Ronald J. Molz, Mt. Kisco, NY (US); Dave Hawley, Westbury, NY (US); Richard McCullough, Brooklyn, NY (US)

(72) Inventors: Ronald J. Molz, Mt. Kisco, NY (US); Dave Hawley, Westbury, NY (US); Richard McCullough, Brooklyn, NY (US)

(73) Assignee: SULZER METCO (US) INC., Westbury, NY (US)

(21) Appl. No.: 14/361,972

(22) PCT Filed: Feb. 28, 2012
(86) PCT No.: PCT/US2012/026936

§ 371 Date: May 30, 2014

(51) Int. Cl. C23C 4/12; H05H 1/34

(52) U.S. Cl. CPC C23C 4/127; H05H 1/34; H05H 2001/3452
USPC 219/121.47; 219/121.48; 219/121.52

(57) ABSTRACT

Plasma gun and method of applying powder to a substrate with a plasma gun. The plasma gun includes a cathode assembly (1), an anode (2), a rear neutrode (7), and an extended neutrode (8) positioned adjacent the rear neutrode (7) to define a channel bore (3) between the cathode assembly (1) and the anode (2). The extended neutrode (8) has a length greater than 38 mm. The plasma gun can also include at least one gas inlet to supply a gas to the channel bore (3) and a power supply.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A COMPACT DISK APPENDIX

Not applicable.

### BACKGROUND OF THE INVENTION

1. Field of the Invention

The invention relates to plasma guns, and in particular to extended cascade plasma guns for plasma spray depositing of a powder onto a substrate.

2. Discussion of Background Information

In the development of plasma guns, designers and engineers have sought to achieve as high a gun voltage as feasible to permit high power levels while maintaining the lowest possible current. Conventional plasma guns are limited in voltage capability by the gun geometry and use high potential secondary gases to increase voltage and to increase other plasma characteristics such as high enthalpy.

The ability to extend the cascading of a plasma arc inside a plasma gun is limited by the overall potential to complete the arc circuit from cathode to anode. Based on experience with conventional plasma guns, the extending and alteration of the nozzle bore to increase voltage was rarely fruitful at all and where it did work only limited improvements to gun voltage were achieved. Lack of clear understanding as to the nature of the interaction between the gas and electric arc during startup and operation limited the ability to formulate a solution to the problem. Similar problems were expected with extending the neutrode segments of a cascade type plasma gun and little experimentation was done.

U.S. Pat. No. 5,406,046 discloses a cascade plasma gun having a neutrode formed by a rear neutrode and a plurality of neutrode segments, e.g., six segments. Moreover, this cascade plasma gun includes a cathode assembly having three cathode elements. The disclosure of this document is expressly incorporated by reference herein in its entirety.

### SUMMARY OF THE EMBODIMENTS

Embodiments of the invention are directed to an extended cascade plasma gun having an extended neutrode stack longer than conventional cascade plasma guns. As a result of the longer neutrode stack, a longer arc having a higher voltage and lower current than in conventional cascade plasma guns is generated between a cathode assembly and an anode.

In embodiments, a combination of a laminar flow state in the channel bore produces clean gas streamlines and lower current conditions promote the formation of very long arcs inside the gun. The operation of the extended cascade plasma gun according to embodiments can be achieved without the need for excessive voltages and/or without any potential for neutrode segments to short out.

Embodiments of the invention are directed to a plasma gun. The plasma gun includes a cathode assembly, an anode, a rear neutrode, and an extended neutrode positioned adjacent the rear neutrode to define a channel bore between the cathode assembly and the anode. The extended neutrode has a length greater than 38 mm. The plasma gun can also include at least one gas inlet to supply a gas to the channel bore and a power supply.

According to embodiments, the extended neutrode may include a plurality of cylindrical neutrode segments axially arranged along the length of the extended neutrode. The plasma gun can also include a plurality of insulators. At least one insulator can be arranged adjacent to each of the plurality of neutrode segments. At least one insulator may be arranged between the extended neutrode and the anode and between the extended neutrode and the rear neutrode. Moreover, the plurality of neutrode segments can include 4-12 neutrode segments. The plurality of neutrode segments may have an axial thickness of 3.5-5.5 mm. Accordance to further embodiments, each of the plurality of neutrode segments can have an axial thickness of 4-5 mm, and in particular an axial thickness of about 4.5 mm. In still other embodiments, each of the plurality of neutrode segments may have an axial thickness of 7-12.5 mm, in particular, an axial thickness of 8-11 mm, and more particularly, an axial thickness of about 9.3 mm. Further, each of the plurality of neutrode segments can have a same axial thickness.

In accordance with other embodiments of the instant invention, the power supply can be operated at greater than 200 V. The power supply can provide an output power of 75 kW-125 kW, in particular 90 kW-110 kW, and more particularly about 100 kW.

According to still other embodiments, the power supply can generate an arc between the cathode assembly and the anode having a current lower than 500 A. Further, the arc current may be within a range of 300 A-375 A.

Moreover, the cathode assembly can include a plurality of cathode elements arranged in a cathode insulator. In embodiments, the plurality of cathode elements may include three cathodes. Further, the plurality of cathode elements may be arranged parallel to each other and parallel to a longitudinal axis of the channel bore.

In accordance with further embodiments, the plasma gun can also include a powder injector coupled to the anode.

According to still other embodiments, the at least one gas can include only one of argon, helium, or nitrogen.

In accordance with embodiments, the at least one gas comprises a combination of at least two of argon, helium, nitrogen, and hydrogen.

Embodiments of the invention are directed to a method of applying a powder to a substrate. The method includes supplying at least one gas from a cathode assembly to an anode via a channel bore, the channel bore having a length of greater than 38 mm, and generating an arc between the cathode assembly and the anode.

According to other embodiments, the arc can be generated with a power supply operating at greater than 200 V. Further, the power supply can be operated at 250V-400V, and particularly at 275V-315V.

In accordance with still yet other embodiments of the present invention, the channel bore can be formed through an extended cascade neutrode that can include a plurality of axially aligned neutrode segments.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention:

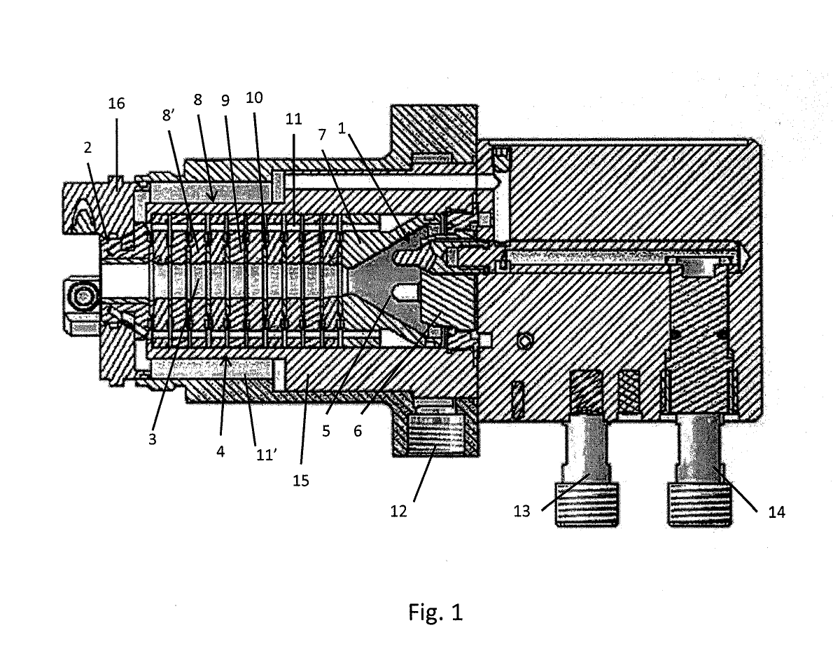

The FIG. 1 illustrates a plasma gun having an extended cascade in accordance with embodiments of the invention.

### DETAILED DESCRIPTION OF THE EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

The plasma spray apparatus shown in the FIG. 1 includes a cathode assembly 1 and an anode 2 separated by a plasma channel 3, which is defined by a ring-shaped interior of a neutrode assembly 4, also referred to as a channel bore.

By way of non-limiting example, cathode assembly 1 can include a plurality of cathodes 5, e.g., three cathodes. Cathodes 5 may be formed with, e.g., a tungsten coating on a copper base, and the plurality of cathodes 5 may be arranged in a housing 6 formed by an electrically insulating material, e.g., boron nitride or other suitable insulating material. By way of further non-limiting example, anode 2 can be of annular design and neutrode assembly 4 may be formed by a rear neutrode 7 and a neutrode stack 8 formed by plurality of neutrode segments 8′ having electrical insulators 9 and O-rings 10 arranged between neighboring neutrodes 5. In this manner the neutrode segments 8′ are electrically insulated from each other and neutrode stack 8 is gas tight. Anode 2 can be formed by, e.g., copper and may also include, e.g., a tungsten surface on the interior ring surface. Rear neutrode 7 and neutrode segments 8′ can be formed from copper and can also include a tungsten lining. Insulators 9 can be formed by boron nitride, aluminum nitride or other suitable material.

The interior ring surface of anode 2 and the interior ring surface of neutrode assembly 4 are coaxially arranged so that current from cathodes 5 extend through plasma channel 3 to anode 2. Moreover, the plurality of cathodes 5 are arranged parallel to each other and parallel to the coaxial alignment of anode 2 and neutrode assembly 4. Further, rear neutrode 7 and neutrode stack 8 are further aligned so that cooling channels 11 are formed around the periphery of neutrode assembly 4. Moreover, neutrode assembly 4 is arranged in an insulated neutrode housing 15, which can be formed by boron, aluminum or other suitable material. Cooling channels 11 receive cooling water through inlet 12 to supply the cooling water through neutrode assembly 4 and into anode 2. The cooling water is then supplied through return channels 11′ to a respective outlet. By way of non-limiting example, the apparatus can include a cooling water outlet for each cathode 5. In the illustrated embodiment, only outlets 13 and 14 are shown, but it is understood that an additional outlet would be respectively provided for each cathode. An injection holder 16 can be arranged around anode 2 and held in place by a nozzle nut (not shown). Injection holder 16 includes a plurality of powder outlets 16 to supply powder into a plasma emitted from anode 2.

Most known cascade guns use no more than six or seven neutrode segments to cascade the arc upon ignition to the anode. By increasing the overall length of the neutrode stack beyond that of the known cascade guns, the inventors have designed the embodiments to ensure that an increased open circuit voltage potential could be achieved and that the potential for the arcs to ride the walls of the neutral segments was essentially eliminated.

In the conventional cascade plasma guns, individual neutrode segments generally have a thickness of about 4.5 mm (0.177 inches) in the axial direction and an overall length of the conventional stack is about 15-35 mm. In embodiments of the invention, the individual neutrode segments can have a thickness (in the axial direction) of 3.5-5.5 mm, and in particular 4-5 mm. In a non-limiting example, the thickness of a neutrode segment can be 4.5 mm. Thus, while embodiments of the invention utilize neutrode segments having a similar thickness the neutrode segments of the conventional plasma gun, in contrast to the conventional guns, embodiments of the invention utilize a neutrode stack 8 having a length greater than the above-noted conventional stack, and in particular greater than 38 mm. In embodiments, the length of neutrode stack 8 can be 40-70 mm, and in particular 50-65 mm. In a non-limiting example, the length of the neutrode stack can be 56 mm. Moreover, it is to be understood that even longer length neutrode stacks can be achieved without departing from the spirit and scope of the embodiments of the invention through the use of an improved power supply.

In particular embodiments, neutrode stack 8 can include at least 6 neutrode segment, and in particular 8 or more neutrode segments 8′ to achieve the desired stack length. Moreover, in a non-limiting example, neutrode stack 8 may include at least 10 neutrode segments 8′.

In other embodiments, neutrode segments 8′ can be formed with a greater thickness than in conventional cascade plasma guns. By way of non-limiting example, neutrode segments 8′ can be formed with a thickness of about twice the thickness of a conventional neutrode segment, about 7 mm-12.5 mm, and in particular about 8-11 mm. In a non-limiting example, the thickness of a neutrode segment can be 9.3 mm (0.366 inches). While the thicker neutrode segments 8′ of this embodiment can be arranged to form a neutrode stack having a length corresponding to the above-described conventional plasma gun, according to embodiments, neutrode stack 8 can be formed with, e.g., 4-6 neutrode segments 8′ in order to achieve the desired extended stack length of at least 38 mm, in particular a stack length of 40-70 mm, more particularly, a stack length of 50-65 mm, and by way of non-limiting example, a stack length of at least 56 mm. These embodiments may be advantageous in that it has been found that, when the neutrode stack is formed with thicker neutrode segments (as compared to conventional neutrode stacks), shorting out through the O-rings separating the segments is significantly reduced.

As is known, a plasma gas is supplied from the area of cathode assembly 1 through neutrode assembly 4. To ignite the plasma gas, a power supply is connected between cathodes 5 and anode 2 with a potential sufficient to ionize the gas to provide a path from each of the plurality of cathodes 5, through neutrodes 4, to anode 2. As the neutrode stack 8 in accordance with embodiments is designed to be longer than in conventional cascade plasma guns, a longer arc is required from cathodes 5 to anode 2. However, despite requiring a longer arc, a same power for the plasma spray apparatus embodiments of the invention as in the conventional cascade plasma guns is sought. In order to compensate for the longer arc, the voltage and current levels are adjusted to achieve the same power. In embodiments, the power can be 75 kW-125 kW, in particular 90 kW-110 kW, and more particularly about 100 kW. In order to facilitate the generation of the longer arcs, in embodiments, the plasma gas can be, e.g., one of argon, helium, or nitrogen, or can be a combination of any two of argon, helium, nitrogen, and hydrogen.

In accordance with the embodiments, the plasma gun with an extended cascade neutrode stack 8 achieves laminar flow conditions in the channel bore. With a power supply capable of greater than 200 V operation, in particular 250V-400V operation, more particularly 275V-315V operation, and in a non-limiting example about 300 V operation, embodiments of the extended cascade neutrode stack can be formed having more neutrode segments than in the convention gun, e.g., an additional 2-6 neutrode segments more than in the conventional cascade neutrode stack. As a result, embodiments of the invention provide for a lighting of the gun and for normal operation with a commensurate increase in gun voltage as compared to standard length cascade neutrode stacks (with six neutrode segments) at same operating power parameters. With an extended cascade neutrode stack of 8-12 neutrode segments, and particularly 10 neutrode segments, the gun can be ignited and operated at an additional 40-100V, and in particular about 60V over the standard length cascade neutrode stacks when using argon as the primary gas and no secondary gas. In the extended cascade neutrode stack according to the embodiments, the voltage limit of the power supply can be quickly reached when primary gas flows are increased or secondary gas, such as helium, is used to boost the voltage.

As a consequence of the increasing voltage, the required amperage to achieve the desired power level is substantially reduced. This advantageously leads directly to increased hardware life. Because conventional cascade plasma guns generally use a power supply operated at 200 V, a 500 amp current can be generated from cathode to anode. To generate the longer arcs, embodiments of the invention utilize a power supply operated at greater than 200 V, in particular 250V-400V, more particularly 275V-315V, and in accordance with a non-limiting example about 300 V, which results in a reduction in a generated current of less than 500 A. In particular, the generated current can be 200 A-425 A, and in particular 300 A-375 A (e.g., by way of non-limiting example the generated current can be about 333 A). Moreover, the inventors have found that, with regard to plasma spray depositing of powders on a substrate, current and voltage are interchangeable, i.e., the powder does not care whether the power is generated by voltage or current. Thus, in embodiments, even though the current is significantly reduced through the use of the high voltage power supply, there is no diminution in powder distribution and coating.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A plasma gun comprising:
a cathode assembly;
an anode;
a rear neutrode;
an extended neutrode positioned adjacent the rear neutrode to define a channel bore between the cathode assembly and the anode, the extended neutrode having a length greater than 38 mm;
at least one gas inlet to supply a gas to the channel bore; and
a power supply.

2. The plasma gun in accordance with claim 1, wherein the extended neutrode comprises a plurality of neutrode segments axially arranged along the length of the extended neutrode.

3. The plasma gun in accordance with claim 2, further comprising a plurality of insulators, wherein at least one insulator is arranged adjacent to each of the plurality of neutrode segments.

4. The plasma gun in accordance with claim 3, wherein at least one insulator is arranged between the extended neutrode and the anode and between the extended neutrode and the rear neutrode.

5. The plasma gun in accordance with claim 2, wherein the plurality of neutrode segments comprises 4-12 neutrode segments.

6. The plasma gun in accordance with claim 5, wherein each of the plurality of neutrode segments have an axial thickness of 3.5-5.5 mm, in particular, an axial thickness of 4-5 mm, and more particularly an axial thickness of about 4.5 mm.

7. The plasma gun in accordance with claim 5, wherein each of the plurality of neutrode sections has an axial thickness of 7-12.5 mm, in particular, an axial thickness of 8-11 mm, more particularly an axial thickness of about 9.3 mm.

8. The plasma gun in accordance with claim 5, wherein each of the plurality of neutrode segments has a same axial thickness.

9. The plasma gun in accordance with claim 1, wherein the power supply is operated at greater than 200 V, in particular, is operated at 250V-400V, and more particularly operated at about 300 V; and

10. The plasma gun in accordance with claim 1, wherein the power supply provides an output power of 75 kW-125 kW, in particular, an output power of 90 kW-110 kW, and more particularly an output power of 100 kW.

11. The plasma gun in accordance with claim 1, wherein the power supply generates an arc between the cathode assembly and the anode having a current lower than 500 A, and in particular, within a range of 300 A-375 A.

12. The plasma gun in accordance with claim 1, wherein the cathode assembly comprises a plurality of cathode elements arranged in a cathode insulator.

13. The plasma gun in accordance with claim 12, wherein the plurality of cathode elements comprises three cathodes.

14. The plasma gun in accordance with claim 12, wherein the plurality of cathode elements are arranged parallel to each other and parallel to a longitudinal axis of the channel bore.

15. The plasma gun in accordance with claim 1, further comprising a powder injector coupled to the anode.

16. The plasma gun in accordance with claim 1, wherein the at least one gas comprises only one of argon, helium, or nitrogen.

17. The plasma gun in accordance with claim 1, wherein the at least one gas comprises a combination of at least two of argon, helium, nitrogen, and hydrogen.

18. A method of applying a powder to a substrate, comprising:
supplying at least one gas from a cathode assembly to an anode via a channel bore, the channel bore having a length of greater than 38 mm;
generating an arc between the cathode assembly and the anode.

19. The method in accordance with claim 18, wherein the arc is generated with a power supply operating at greater than 200V, in particular is operated at 250V-400V, and is more particularly operated at about 275V-315V.

20. The method in accordance with claim 18, wherein the channel bore is formed through an extended cascade neutrode comprising a plurality of axially aligned neutrode segments.
